(19) United States
(12) Patent Application Publication
(10) Pub. No.: US 2007/0103321 A1
(43) Pub. Date: May 10, 2007

(54) Electronic device capable of detecting an object and method thereof

(75) Inventor: Ching-Sung Yen, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/518,148

(22) Filed: Sep. 11, 2006

(30) Foreign Application Priority Data
Sep. 15, 2005 (TW) 094131908

(51) Int. Cl. G08B 21/00

(52) U.S. Cl. 340/608; 340/686.6

(57) ABSTRACT

An electronic device includes a sensor for sensing whether an object blocks a vent, and a logic unit electrically connected to the sensor for controlling operation of the electronic device according to a sensing result of the sensor. The logic unit controls a warning interface to present a warning message when the sensor senses the object blocking the vent.

### BACKGROUND OF THE INVENTION

1. Field of the Invention

The present invention relates to an electronic device capable of performing a function according to a sensing result of whether an object blocks a vent of the electronic device and method thereof, and more particularly, to an electronic device capable of controlling a warning interface to present a warning message when an object blocks a vent of the electronic device and method thereof.

2. Description of the Prior Art

In modern information society, computer systems, such as desktops, notebook computers, servers, and so on, are becoming necessary. The operation speed of a typical computer is becoming faster so that the computer is utilized in a wide variety of fields. Because of the increasing speed, components of the computer generate more heat than before when processing operations. If the heat generated by the components of the computer cannot be dissipated effectively, the stability and operation speed of the computer will be reduced.

Please refer to FIG. 1 and FIG. 2. FIG. 1 is a schematic diagram of a notebook computer 10 of the prior art. FIG. 2 is a diagram of a thermal module 12 of the notebook computer 10. The notebook computer 10 includes a housing 14 for covering internal components. An intake 16 is positioned on a bottom of the housing 14 for air intake, and a vent 18 is positioned on a side of the housing 14 for venting hot air from the thermal module 12 outside the housing 14. The notebook computer 10 further includes a display monitor 20 for displaying operating information of the notebook computer 10, and a speaker 22 for outputting sound signals. The thermal module 12 includes a fan 24 installed above the intake 16 and a heat sink 26 installed between the fan 24 and the vent 18 of the housing 14. A plurality of fins 28 is installed on the heat sink 26 for increasing the heat-dissipating area. The air outside can be sucked in at the intake 16 by the fan 24, be diffused to the plurality of fins 28 on the heat sink 26, and be vented from the vent 18 so as to dissipate heat generated by the components of the notebook computer 10 outside the housing 14 by heat convection.

When an object is positioned close to the vent 18 of the notebook computer 10, the object blocks the hot air vented from the vent 18 by the thermal module 12. Therefore, the heat generated by the components of the notebook computer 10 cannot be dissipated easily, which results in a rapid increase of temperature in the notebook computer 10. This reduces the stability of the notebook computer 10 and the service life of the components of the notebook computer 10.

### SUMMARY OF THE INVENTION

It is therefore a primary objective of the claimed invention to provide an electronic device capable of performing a function according to a sensing result of whether an object blocks a vent of the electronic device for solving the above-mentioned problem.

According to the claimed invention, an electronic device includes a sensor for sensing whether an object blocks a vent, and a logic unit electrically connected to the sensor for controlling operation of the electronic device according to a sensing result of the sensor.

According to the claimed invention, a method for controlling operation of an electronic device according to a sensing result of an object blocking a vent includes sensing whether the object blocks the vent, and controlling the electronic device to perform a corresponding operation according to the sensing result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a notebook computer of the prior art.

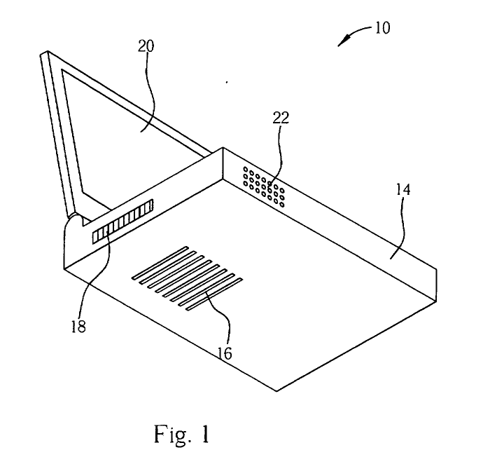

FIG. 2 is a diagram of a thermal module of the notebook computer of FIG. 1.

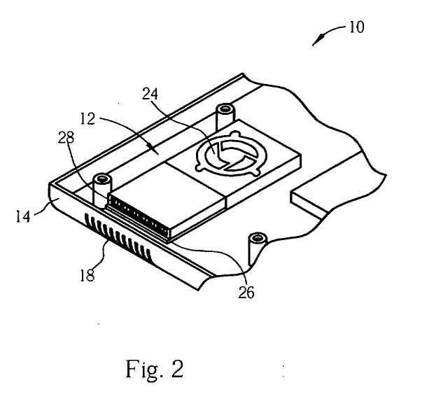

FIG. 3 is a schematic diagram of an electronic device according to the present invention.

FIG. 4 is a diagram of internal components of the electronic device of FIG. 3 according to the present invention.

FIG. 5 is a functional block diagram of the electronic device of FIG. 3 according to the present invention.

FIG. 6 is a diagram of an object blocking a vent of the electronic device according to the present invention.

FIG. 7 is a flowchart of controlling the electronic device to perform a function according to whether the object blocks the vent according to the present invention.

### DETAILED DESCRIPTION

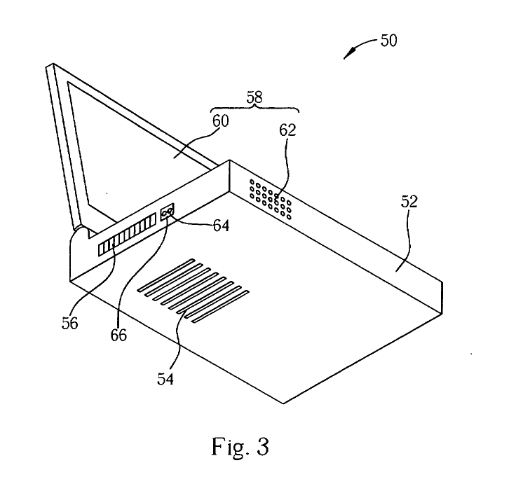

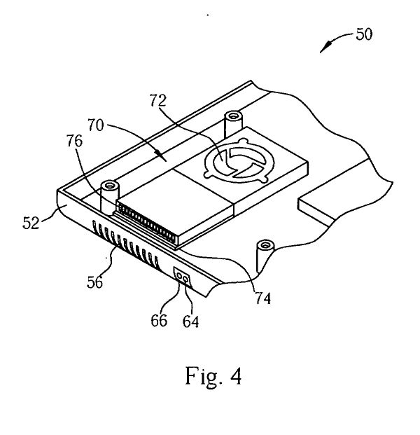

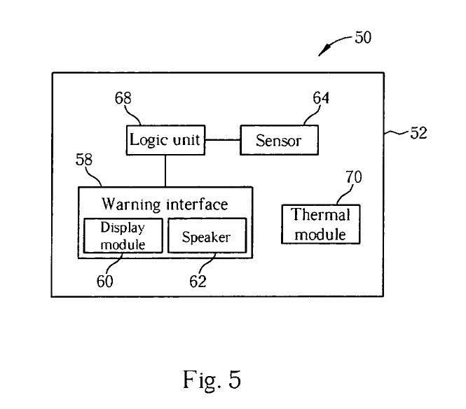

Please refer to FIG. 3, FIG. 4, and FIG. 5. FIG. 3 is a schematic diagram of an electronic device 50 according to the present invention. FIG. 4 is a diagram of internal components of the electronic device 50 according to the present invention. FIG. 5 is a functional block diagram of the electronic device 50 according to the present invention. The electronic device 50 can be a notebook computer. The electronic device 50 includes a housing 52 for covering internal components. An intake 54 is positioned on a bottom of the housing 52 for air intake, and a vent 56 is positioned on a side of the housing 52 for venting hot air to outside the housing 52. The electronic device 50 further includes a warning interface 58 for presenting a warning message. The warning interface 58 includes a display module 60 for displaying operating information of the electronic device 50 so as to present the warning message as an image. The warning interface 58 further includes a speaker 62 for outputting sound signals so as to present the warning message as a sound. The electronic device 50 further includes a sensor 64 installed on a side of the vent 56 for sensing whether an object blocks the vent 56. The sensor 64 can be an optical sensor, an infrared sensor, and so on. The electronic device 50 further includes a translucent plastic component 66 installed outside the sensor 64 for protecting the sensor 64. The translucent plastic component 66 does not reduce the sensing accuracy of the sensor 64 as an opaque plastic component would. The electronic device 50 further includes a logic unit 68 electrically connected to the warning interface 58 and the sensor 64 for controlling operation of the electronic device 50 according to the sensing result of the sensor 64. As shown in FIG. 4, the electronic device 50 further includes a thermal module 70 including a fan 72 installed above the intake 54, and a heat sink 74 installed between the fan 72 and the vent 56 on the housing 52. A plurality of fins 76 is installed on the heat sink 74 for increasing the heat-dissipating area. The air outside can be sucked in at the intake 54 by the fan 72, be diffused to the plurality of fins 76 on the heat sink 74, and be vented from the vent 56 so as to dissipate heat generated by the components of the electronic device 50 to outside the housing 52 by heat convection.

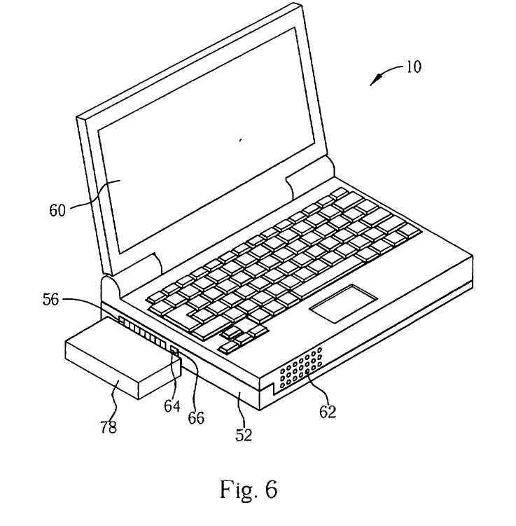

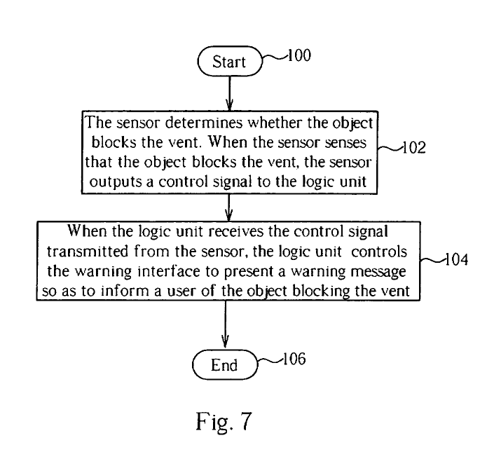

Please refer to FIG. 6. FIG. 6 is a diagram of an object 78 blocking the vent 56 of the electronic device 50 according to the present invention. When the object 78 is positioned close to the vent 56 of the electronic device 50, the object 78 blocks the hot air vented from the vent 56 by the thermal module 70. Therefore, the heat generated by the components of the electronic device 50 cannot be dissipated easily. Please refer to FIG. 7. FIG. 7 is a flowchart of controlling the electronic device 50 to perform a function according to whether the object 78 blocks the vent 56 according to the present invention. The method includes the following steps:
Step 100: Start.
Step 102: The sensor 64 of the electronic device 50 senses whether the object 78 blocks the vent 56. When the sensor 64 senses the object 78 blocking the vent 56, the sensor 64 outputs a control signal to the logic unit 68.
Step 104: When the logic unit 68 receives the control signal transmitted from the sensor 64, that is, the object 78 blocks the vent 56, the logic unit 68 controls the warning interface 58 to present a warning message so as to inform a user of the object 78 blocking the vent 56.
Step 106: End.

When there is no object blocking the vent 56 of the electronic device 50, the sensor 64 does not report anything. When there is the object 78 blocking the vent 56 of the electronic device 50, light emitted from the sensor 64 is reflected back so that the sensor 64 receives light with the same wavelength as the emitted light. Then, the sensor 64 outputs the control signal to the logic unit 68. When the distance between the object 78 and the sensor 64 as sensed by the sensor 64 is less than a predetermined distance, the sensor 64 outputs the control signal to the logic unit 68. That is, when the distance between the object 78 and the vent 56 is less than the predetermined distance, the logic unit 68 controls the warning interface 58 to present the warning message so as to inform the user of the object 78 blocking the vent 56. The sensitivity of the sensor 64 can be adjusted according to the predetermined distance or by selecting the sensor 64 based on sensing distance.

When the logic unit 68 receives the control signal transmitted from the sensor 64, the logic unit 68 controls the warning interface 58 to present the warning message so as to inform the user of the object 78 blocking the vent 56. The logic unit 68 can control the display module 60 to display the warning message as an image, such as by displaying a window showing a message informing the user of the object 78 blocking the vent 56 so as to warn the user to remove the object 78 from the front of the vent 56. The logic unit 68 also can control the speaker 62 to output sound signals so as to present the warning message as a sound, such as a beep or similar noise.

In contrast to the conventional electronic device, the electronic device according to the present invention can alert the user to remove an object from the front of the vent when the object blocks the vent of the electronic device. Therefore, the heat generated by the components of the electronic device can be dissipated easily so as to increase the stability of the electronic device and increase the service life of the components of the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a sensor for sensing whether an object blocks a vent; and
a logic unit electrically connected to the sensor for controlling operation of the electronic device according to a sensing result of the sensor.

2. The electronic device of claim 1 further comprising a warning interface electrically connected to the logic unit, the logic unit for controlling the warning interface to present a warning message according to the sensing result of the sensor.

3. The electronic device of claim 2 wherein the logic unit controls the warning interface to present the warning message when the sensor senses the object blocking the vent.

4. The electronic device of claim 2 wherein the logic unit controls the warning interface to present the warning message when the sensor senses that a distance between the object and the sensor is less than a predetermined distance.

5. The electronic device of claim 2 wherein the warning interface is a display module.

6. The electronic device of claim 2 wherein the warning interface is a speaker.

7. The electronic device of claim 1 further comprising a translucent plastic component installed outside the sensor.

8. The electronic device of claim 1 further comprising a thermal module for dissipating heat from the vent.

9. The electronic device of claim 1 wherein the sensor is an optical sensor.

10. The electronic device of claim 1 being a notebook computer.

11. A method for controlling operation of an electronic device according to a sensing result of an object blocking a vent comprising:
sensing whether the object blocks the vent; and
controlling the electronic device to perform an operation according to the sensing result.

12. The method of 11 wherein controlling the electronic device to perform an operation according to the sensing result comprises controlling the electronic device to present a warning message when sensing the object blocking the vent.

13. The method of 11 wherein controlling the electronic device to perform an operation according to the sensing result comprises controlling the electronic device to present a warning message when sensing a distance between the object and the vent to be less than a predetermined distance.
